(19) United States
(12) Patent Application Publication
(10) Pub. No.: US 2004/0016135 A1
(43) Pub. Date: Jan. 29, 2004

(54) Hole saw funnel and cavity

(76) Inventor: Giovanni Lisa, Emerson, NJ (US)

Correspondence Address: Giovanni Lisa, 100 Patrick Avenue, Emerson, NJ, 07630, US

(21) Appl. No.: 10/160,534

(22) Filed: Jul. 29, 2002

(51) Int. Cl. B26D 1/00; B26D 3/00; B25B 21/00

(52) U.S. Cl. 30/500; 83/13

(57) ABSTRACT

My invention works in accordance with a hole saw, (which is a drill/boring hole maker.) The funnel is placed over the hole saw and the cavity is placed in the enclosure box, etc. The cavity is used to capture debris, filings and particles which are being bored and drilled. The pieces are being contained within the cavity to ensure safety and not have pieces cause injury or damage to persons or equipment. My invention gets placed into a drill motor which is used to bore the hole.

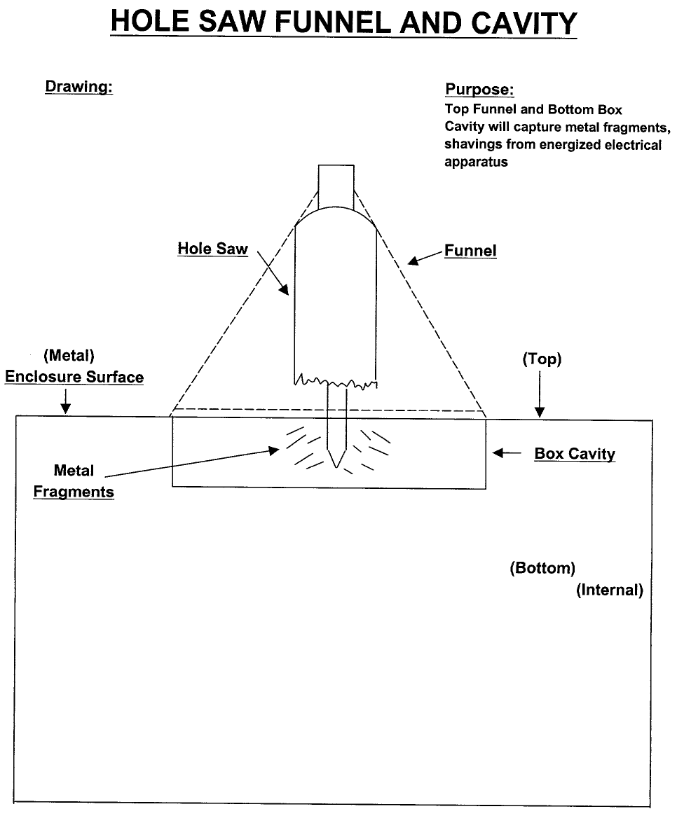

To capture metal fragments, filings and actual circular diameter metal rubbish from a hole saw penetration, in an electrical energized enclosure/panel. (External and internal capturing of metal particles and debris for safety purposes within tool).

Funnel Purpose

To be placed as a housing over a hold saw on the topside of an enclosure to be drilled from. Funnel needs to be magnetized internally and at bottom base so as to capture all drilling metal particles.

Boxed Cavity Purpose

To be placed within a metal electrical enclosure, and supported to the enclosure by a magnetized perimeter seating. Interior walls of boxed cavity to be of a magnetic sheathing. Exterior to be PVC coated or fiberglass lightweight but durable whereas not to become an electrical conductive material.

Note

Sizes of funnel and boxed cavity can vary, depending upon diameter of hole saw.

The advantages of using this product would be a safety issue for the craftsman who is doing the installation, under no circumstances would the installer come in contact with electrical exposed components. Use of this product would also create a productive and efficient installation time frame.

1. What I claim my invention can do is to capture and gather metal filings and keep them contained within a funnel which is placed over a holesaw and the cavity which is a box or enclosure and is placed beneath the partition which is being drilled and bored. The purpose for this is to capture and contain all filings and metal debris so as not to cause injury or damage to personel and equipment. With a drill motor I place the funnel over the holesaw and secure the cavity beneath whereas to gather all drilled debris.
